(19) United States
(12) Patent Application Publication
(10) Pub. No.: US 2002/0072572 A1
(43) Pub. Date: Jun. 13, 2002

(54) Reactive extrusion process with partial condensor and reflux

(76) Inventors: Kenneth W. Russell, Orange, TX (US); Shane A. Warr, Port Neches, TX (US); Gangfeng Cai, Danville, CA (US); Lawrence E. Huff, Kingwood, TX (US); Ta Yen Ching, Novato, CA (US)

Correspondence Address: Kenneth D. Goodman, Williams, Morgan & Amerson, P.C., 7676 Hillmont, Suite 250, Houston, TX, 77040, US

(21) Appl. No.: 09/733,652

(22) Filed: Dec. 8, 2000

(51) Int. Cl. C08F 120/02

(52) U.S. Cl. 525/329.7; 525/330.6

(57) ABSTRACT

An esterification or transesterification process comprises the steps of reacting a first polymer with a first alcohol in a reactive extruder to produce a second polymer, while also producing a second alcohol as a by-product. The second alcohol has a lower boiling point than the first alcohol, preferably at least about 100° C. lower. A gas stream is vented from the extruder apparatus that comprises both the first alcohol and the second alcohol. At least part of the first alcohol is condensed from the gas stream, thereby forming a liquid stream, which is then fed back into the reactive extruder. The condensed first alcohol then continues to further the extent of the reaction in the extruder producing the second polymer.

### BACKGROUND OF THE INVENTION

1. Field of the Invention

This invention relates generally to polymer production. More particularly, it concerns reactive extrusion processes that can be used to make oxygen scavenging polymers. The process of this invention is especially useful in reactive extrusion processes in which a byproduct of the reaction has a boiling point that is at least about 100° C. lower than the boiling point of a reactant.

2. Description of Related Art

Polymers having oxygen-scavenging properties are useful in some food and drink packaging applications. Limiting the exposure of oxygen-sensitive products to oxygen can maintain and enhance the quality and shelf life of the product. In addition, oxygen-scavenging packaging can keep the product in inventory longer, thereby reducing costs incurred from waste and having to restock inventory.

Certain polymer compositions can be difficult and costly to make directly by polymerization from monomers or via solution esterification and/or transesterification. Enabling the reactive process to occur within mixing equipment (such as an extruder) has provided a more economical means to make these polymers.

Oxygen scavenging polymers are known in the art. One such oxygen scavenging polymer and a process for making it are described by Ching et al. (U.S. Pat. No. 5,736,616 and PCT Application No. WO 99/48963). This process involves the esterification or transesterification of a first polymer to produce a second polymer having pendant ester moieties that can scavenge oxygen. For example, ethylene/methyl acrylate copolymer (EMAC) can be reacted with 3-cyclohexene-1-methanol to form poly(ethylene/methyl acrylate/cyclohexene-methyl acrylate) (EMCM). However, this reaction also produces by-products such as methanol or isopropanol. The presence of by-products such as methanol tends to drive the reaction in the reverse direction, which decreases the effectiveness and yield of the process. Therefore, it is necessary to prevent the buildup of methanol and other alcohol by-products within the process.

There is a need for improved polymer manufacturing processes that can achieve good reaction rates, high conversion (e.g., from EMAC to EMCM) and high yields with use of lesser amounts of reactants (e.g., alcohol) and catalyst and without excessive loss of reactants.

### SUMMARY OF THE INVENTION

The present invention relates to reactive extrusion processes used to produce polymers.

One aspect of the invention is an esterification or transesterification process that comprises the steps of reacting a first polymer with a first alcohol in a reactive extruder to produce a second polymer, venting a gas stream from the extruder apparatus that comprises both the first alcohol and a second alcohol, condensing at least part of the first alcohol from the gas stream, thereby forming a liquid stream, and refluxing the liquid stream back into the reactive extruder. The second alcohol is produced as a reaction by-product and has a lower boiling point than the first alcohol, preferably a boiling point that is at least about 100° C. lower than the boiling point of the first alcohol.

The volatile components can be vented from the reactive extruder at one or more locations along the extruder length, and this venting is preferably done at greater than atmospheric pressure, although the particular pressure used will depend on the volatility of the compounds being vented.

The condensing of the gas stream can be accomplished by using a partial condenser apparatus, which optionally can also sub-cool the condensed stream below its boiling point. The partial condenser can be used to control various parameters of the vapor vent stream exiting the partial condenser, such as the temperature or composition. This can be accomplished by means of a temperature controller or a composition analyzer on the vapor vent stream that controls the function of the partial condenser.

A contact section can be located between the partial condenser and the reactive extruder apparatus so that the liquid stream can contact the gas stream, which can enhance recovery of the first alcohol.

In some embodiments of the invention, the first polymer has an ethylenic backbone. For example, the first polymer can comprise an ethylene-alkyl acrylate copolymer.

The first alcohol can comprise a terminal cycloalkenyl group, such as a cycloalkenyl group having the formula (I):

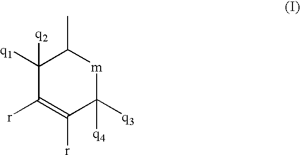

wherein q₁, q₂, q₃, q₄, and r are independently selected from hydrogen, methyl, or ethyl; m is —(CH₂)ₙ—, wherein n is an integer from 0 to 4, inclusive; and, when r is hydrogen, at least one of q₁, q₂, q₃, and q₄ is also hydrogen.

The reaction of the first polymer and the first alcohol produces a second polymer that comprises pendant groups having the formula (I) as shown above. In one preferred embodiment, the second polymer comprises an ethylene/alkyl acrylate/cycloalkenyl-alkyl is acrylate terpolymer, such as poly(ethylene/methyl acrylate/cyclohexene-methyl acrylate) (EMCM).

The second alcohol can comprise, for example, methanol, isopropyl alcohol, or a mixture of the two.

Some embodiments of the present invention can increase conversion of the first polymer to the second polymer by as much as 10% or even more, compared to prior art transesterification processes. In some situations, the process can achieve conversion of at least about 45%.

### BRIEF DESCRIPTION OF THE DRAWINGS

The advantages and features of the present invention can be more fully understood by referring to the following detailed description and by reference to the attached drawings, in which:

FIG. 1 illustrates a transesterification reaction scheme that can be performed using the present invention.

FIG. 2 is a simplified flow sheet of a reactive extrusion process with a partial condenser apparatus on the vent stream.

FIG. 3 shows an embodiment of the present invention that includes a contact section between the reactive extruder and the partial condenser.

FIG. 4 illustrates a method of control for the partial condenser.

### DESCRIPTION OF ILLUSTRATIVE EMBODIMENTS

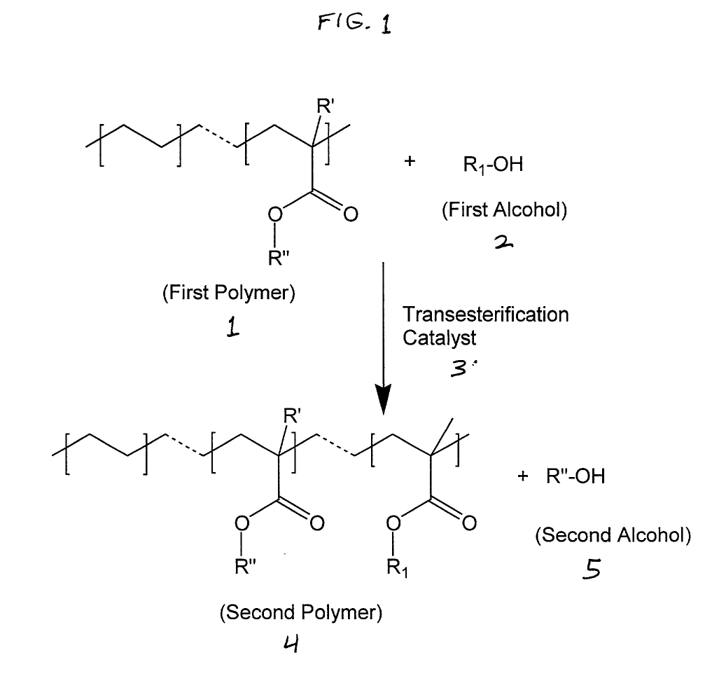

FIG. 1 shows a suitable reaction scheme for the process of the present invention. A first polymer 1, such as EMAC, is reacted with a first alcohol 2, such as 3-cyclohexene-1-methanol, in the presence of a transesterification catalyst 3. The reaction transesterifies the first polymer 1 to form a second polymer 4, such as EMCM, and a second alcohol 5.

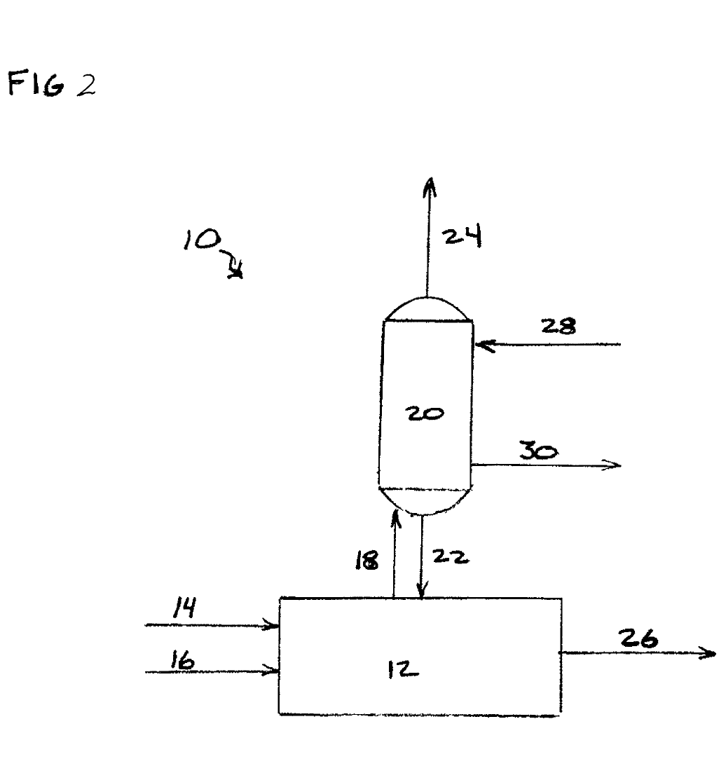

As shown in FIG. 2, the reactive extruder process (indicated generally as 10) includes a reactive extruder apparatus 12 into which the first polymer 14 and the first alcohol 16 are injected. The reactive extruder 12 is preferably an intermeshing twin screw type apparatus. Examples of suitable apparatus include Wemer-Pfleiderer models ZSK-30 and ZSK-40. Uniform and intensive mixing is particularly preferred. An extruder may be used in series with one or more additional extruders or with other processing equipment. When one extruder is used, it optionally can be divided into at least two zones, a reactive zone and a devolatilization zone. The pressure in the reaction zone is typically selected on the basis of the vapor pressure or boiling point of the transesterifying compound (i.e., first alcohol) used, and can be at essentially atmospheric pressure for many transesterifying compounds. The reaction zone alternatively may be under slight pressure due to the heat and extruder's action on the polymer. The devolatilization zone removes volatile materials from the transesterified polymer.

The transesterification reaction described by Ching et al. (U.S. Pat. No. 5,736,616) is an equilibrium reaction in which a polyolefin is reacted with an alcohol (e.g. cyclohexene methanol, benzyl alcohol, NOPOL) within a reactive extruder, producing a terpolymer and a light alcohol byproduct (e.g. methanol, isopropanol). As the reaction progresses, the level of light alcohol byproduct increases which drives the reaction in the reverse direction according to the Le Chatlier's principle. To drive the reaction forward toward an acceptable degree of reaction, the undesirable alcohol by-product (i.e., the second alcohol) must be removed.

A gas stream 18 comprising volatile compounds is vented from the extruder at one or more locations along the length of the extruder 12. This gas stream 18 typically comprises a mix of alcohols, including some of the first alcohol along with one or more second alcohols (light alcohol byproducts from the reaction) such as methanol and isopropyl alcohol. The second alcohol or alcohols will generally have a lower boiling point than the first alcohol. The gas stream 18 is fed to a partial condenser 20 in which the heavier components are condensed to form a liquid stream 22, comprising the majority of the first alcohol contained in the gas stream. The liquid stream 22 is then fed back into the extruder 12 for further reaction with the first polymer 14. It is preferred that the liquid stream 22 be sub-cooled prior to being fed back into the reactive extruder 12. Sub-cooling is here meant to describe the cooling of the liquid stream to a temperature that is less than its vaporization temperature. Having a sub-cooled liquid stream is beneficial in that it allows the liquid stream 22 to contact and mix with the polymer melt within the reactive extruder 12 without flashing back to a vapor phase upon contact with the hot polymer melt. Temperature indicators can be installed on the gas stream 18, liquid stream 22 and the vapor vent stream 24 and may be beneficial in operation and control of the process.

The lighter components of the gas stream 18 remain in a vapor phase and exit the partial condenser 20 as a vent stream 24 and are removed from the process. The composition of this vent stream 24 is predominantly the lighter alcohol byproducts such as methanol and/or isopropyl alcohol. The reactive extruder 12 produces a second polymer stream 26 that comprises the polymer with the desired characteristics (such as oxygen scavenging capabilities) along with any unreacted feed and various byproducts.

As shown in FIG. 1 the partial condenser 20 comprises a cooling fluid inlet 28 and a cooling fluid outlet 30. The partial condenser 20 will typically be of a shell and tube design utilizing water or steam as a cooling fluid, although other types of condensers could also be used such as air cooled exchangers. Condensers that use materials such as FREON or propane as refrigerants could also be used.

When the first polymer is EMAC and the second polymer is EMCM, preferably the melt temperature in the extruder is about 220-300° C., more preferably about 250-265° C. The temperature in the partial condenser should be between the boiling point of the first and second alcohols, preferably about 65-160° C., more preferably about 65-105° C. When a ZSK-30 reactive extruder apparatus is used, preferably the partial condenser temperature is 80-160° C. and the pressure is 4-10 in Hg.

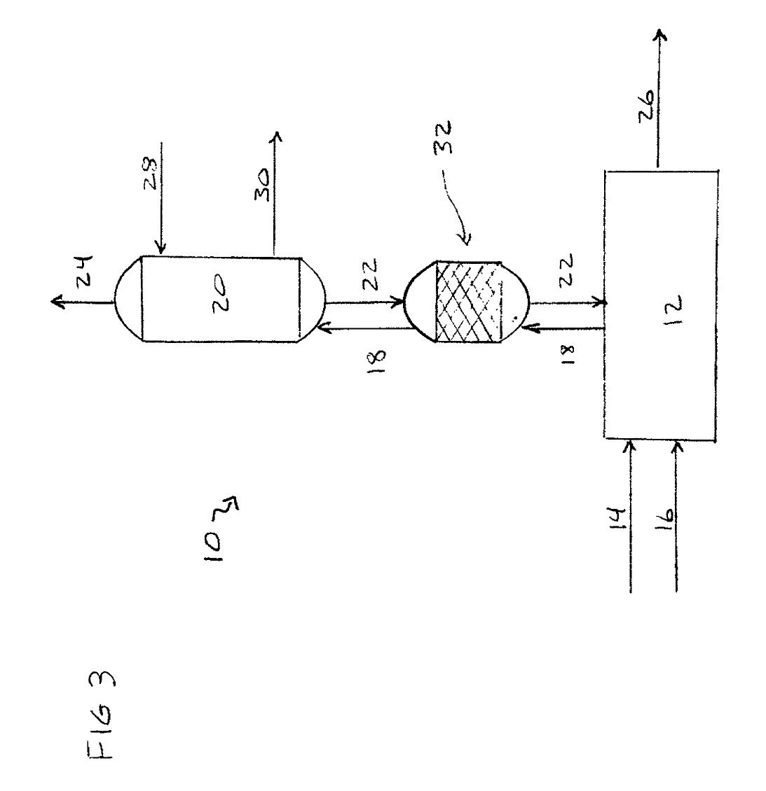

FIG. 3 shows an alternative embodiment in which a contact section 32 comprising packing, baffles or trays is placed between the extruder 12 and the partial condenser 20. This section provides additional surface area for contact between the gas stream 18 and the liquid stream 22 that will aid in the separation of the first and second alcohols. The contact section can comprise either a packed section, a trayed section, or a combination of the two.

A packed section can comprise any of the types of packing known to those skilled in the art, like “structured” packing such as a formed wire mesh material. The packed section could also comprise “fill” packing such as Berl saddles, Raschig rings, Pall rings or material as simple as crushed glass. Materials of construction of the packing can include ceramic, glass, plastic or various metals depending on the specific application.

A trayed section can comprise tray variations such as valve or bubble cap trays, sieve trays, or baffle plates. These are typically made of metal and are designed to provide multiple trays for efficient vapor-liquid contact.

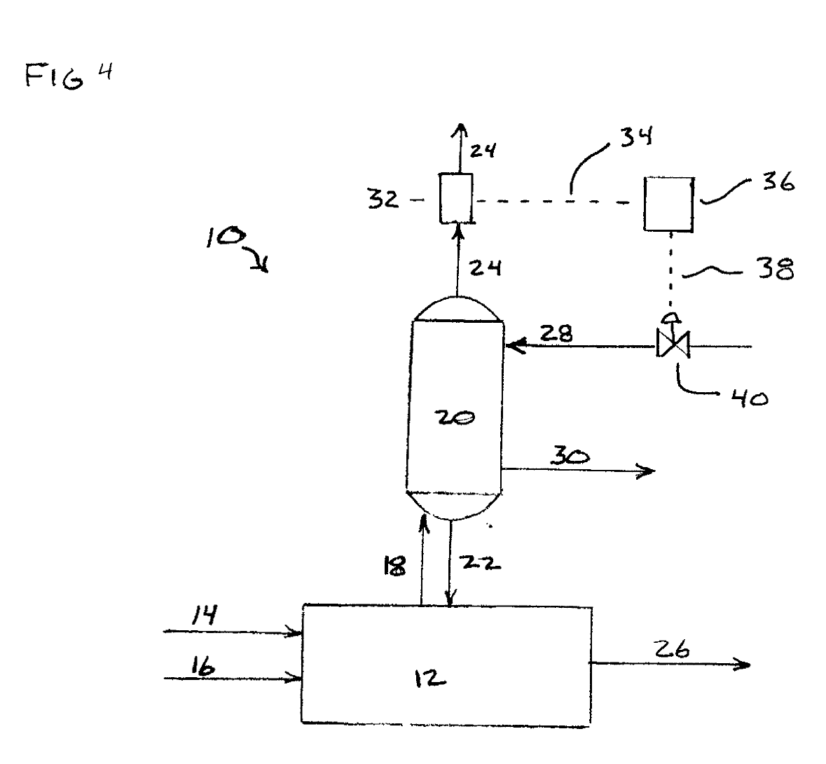

FIG. 4 illustrates a method to control the amount of heat removed by the partial condenser 20. A device 32 (such as a temperature transmitter or a composition analyzer) on the vent stream 24 transmits a signal 34 to a condenser control device 36. The condenser control device output 38 varies in relation to the deviation of the device signal 34 from a desired set point. The condenser control device output 38 is sent to a flow control valve 40 located on the cooling water flow stream 30. The flow control valve 40 will regulate the tempered water flow rate and therefore regulate the amount of heat removed from the gas stream 18. In this way the partial condenser can be controlled to allow substantially all of the lighter alcohol byproducts such as methanol or isopropyl alcohol to be removed from the process while minimizing the loss of heavier alcohols such as those contained in the first alcohol stream 16.

The first polymer contains a polyethylenic backbone and preferably a plurality of acrylate monomer units (e.g., the first polymer can be an ethylene-alkyl acrylate copolymer).

The first alcohol preferably comprises a cycloalkenyl group having the formula (I):

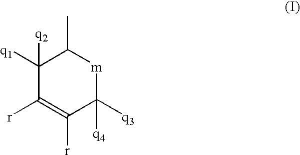

wherein q₁, q₂, q₃, q₄, and r are independently selected from hydrogen, methyl, or ethyl; m is —(CH₂)ₙ—, wherein n is an integer from 0 to 4, inclusive; and, when r is hydrogen, at least one of q₁, q₂, q₃, and q₄ is also hydrogen.

Preferably, the first alcohol has structure II:

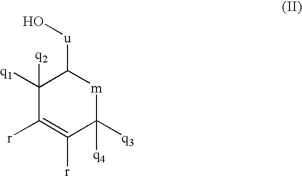

wherein q₁, q₂, q₃, q₄, r, and m are as described above, and u is —(CH₂)ᵥ—, wherein v is an integer from 0 to 12, inclusive.

The second polymer has an ethylenic backbone and preferably has a cyclic olefinic pendant group that has the structure (I) as shown above. The second polymer optionally can further comprise a linking group that links the backbone to the cyclic olefinic pendant group. Preferred polymers that have an ester linking group (—COO—) between their cyclic olefinic pendant groups and their backbones include ethylene/methyl acrylate/cyclohexenyl methyl acrylate terpolymer (EMCM).

The second polymer can be used to make various packaging materials, such as a single or multilayer film, or a rigid, semi-rigid, or flexible packaging article that has a single layer or multiple layers.

The second polymer can become part of an oxygen scavenging composition that also comprises a transition metal catalyst. The transition metal catalyst accelerates the rate of oxygen scavenging. Though not to be bound by theory, useful catalysts include those which can readily interconvert between at least two oxidation states. See Sheldon, R. A.; Kochi, J. K.; “Metal-Catalyzed Oxidations of Organic Compounds” Academic Press, New York 1981.

Preferably, the catalyst is in the form of a salt, with the transition metal selected from the first, second or third transition series of the Periodic Table. Suitable metals and their oxidation states include, but are not limited to, manganese II or III, iron II or III, cobalt II or III, nickel II or III, copper I or II, rhodium II, III or IV, and ruthenium. The oxidation state of the metal when introduced need not necessarily be that of the active form. The metal is preferably iron, nickel, manganese, cobalt or copper; more preferably manganese or cobalt; and most preferably cobalt. Suitable counterions for the metal include, but are not limited to, chloride, acetate, stearate, oleate, palmitate, 2-ethylhexanoate, neodecanoate or naphthenate. Preferably, the salt, the transition metal, and the counterion are either on the U.S. Food and Drug Administration GRAS (generally regarded as safe) list, or exhibit substantially no migration to the product from the oxygen scavenging composition when it is part of a packaging article (i.e. less than 50 ppb in edible dietary intake (EDI)). Particularly preferable salts include cobalt oleate, cobalt stearate, and cobalt neodecanoate. The metal salt can also be an ionomer, in which case a polymeric counterion is employed. Such ionomers are well known in the art. Typically, the amount of transition metal catalyst can range from 0.001 to 3% (10 to 30,000 ppm) the oxidizable organic compound, based on the metal content only (excluding ligands, counterions, etc.).

Antioxidants can be used with oxygen scavenging compositions to control scavenging initiation. An antioxidant as defined herein is a material that inhibits oxidative degradation or cross-linking of polymers. Typically, antioxidants are added to facilitate the processing of polymeric materials or prolong their useful lifetime. In relation to this invention, such additives prolong the induction period for oxygen scavenging in the absence of heat that triggers oxygen scavenging. When it is desired to accelerate the commencement of oxygen scavenging by an oxygen scavenging composition, the composition is exposed to heat that is suited to triggering oxygen scavenging in that particular composition.

Antioxidants such as 2,6-di(t-butyl)-4-methylphenol(BHT), 2,2′-methylene-bis(6-t-butyl-p-cresol), triphenylphosphite, tris-(nonylphenyl)phosphite, dilaurylthiodipropionate, vitamin E, and tetra-bismethylene 3-(3,5-ditertbutyl-4-hydroxyphenyl)-propionate methane are suitable for use with this invention.

The amount of an antioxidant, when present, can also have an effect on oxygen scavenging. As mentioned earlier, such materials are usually present with oxidizable organic compounds or additional polymers to prevent oxidation or gelation of the polymers. Typically, they are present in about 0.01 to 1% by weight of the oxidizable organic compound. However, additional amounts of antioxidant can also be added if it is desired to tailor the induction period.

Oxygen scavenging compositions of the present invention can comprise one or more additional polymers. Such additional polymers can be structural polymers that are thermoplastic and render the oxygen scavenging composition more adaptable for use in a packaging article. Suitable structural polymers include, but are not limited to, polyethylene, low density polyethylene, very low density polyethylene, ultra-low density polyethylene, high density polyethylene, polyethylene terephthalate (PET), polyvinyl chloride, and ethylene copolymers such as ethylene-vinyl acetate, ethylene-alkyl (meth)acrylates, ethylene-(meth)acrylic acid, and ethylene-(meth)acrylic acid ionomers. In rigid articles, such as beverage containers, PET is often used. Blends of different structural polymers can also be used. However, the selection of the structural polymer largely depends on the article to be manufactured and the end use thereof. Such selection factors are well known in the art. For instance, the clarity, cleanliness, effectiveness as an oxygen scavenger, barrier properties, mechanical properties, or texture of the article can be adversely affected by a blend containing a structural polymer that is incompatible with the oxidizable organic compound.

An oxygen scavenging composition of the present invention can be used in a film or a packaging article, including a component (integral or non-integral) of a packaging article. When provided in the form of a film, the film can be autonomous or can be an integral or non-integral part of a packaging article. Packaging articles suitable for comprising oxygen scavenging compositions can be flexible, rigid, semi-rigid or some combination thereof. Examples of oxygen scavenging packaging articles that can be used in the present invention, include gable-top cartons, parallelepiped cartons, trays, cups, bags and bottles among other containers. Materials that can be used in making such containers include paper, cardboard, fiberboard, glass or plastic. Such containers can be used as juice cartons, soft drink containers, tofu containers, and beer bottles, among other uses. Rigid packaging articles typically have wall thicknesses in the range of 100 to 1000 micrometers. Typical flexible packages that can be used in the present invention include those used to package food items such as meats, cheeses, fresh pastas, snack foods, or coffees, among others, and they typically have thicknesses of 5 to 250 micrometers. Furthermore, the oxygen scavenging composition can be provided in a non-integral oxygen scavenging component or a layer of a package, e.g., it can be in the form of a coating, a bottle cap liner, an adhesive or a non-adhesive sheet insert, a gasket, a sealant, or a fibrous mat insert, among others. Oxygen scavenging components can also consist of a single layer or multiple layers. Generally, packaging articles (flexible, rigid, semi-rigid, or combinations of these) and packaging components comprising oxygen scavenging compositions can be used in packaging any product for which it is desirable to inhibit oxygen damage during storage, e.g. foods, beverages, cosmetics, pharmaceuticals, medical products, corrodible metals, or electronic devices, among others.

As stated above, the oxygen scavenging composition can be provided as an article that has a single layer or multiple layers. An oxygen scavenging layer comprises the oxidizable organic compound. When a packaging article or film comprises an oxygen scavenging layer, it can further comprises one or more additional layers, one or more of the additional layers can comprise an oxygen barrier layer, i.e. a layer having an oxygen transmission rate equal to or less than 100 cubic centimeters per square meter (cc/m²) per day per atmosphere at room temperature (about 25° C.). Typical oxygen barriers comprise poly(ethylene vinylalcohol), polyacrylonitrile, polyvinyl chloride, poly(vinylidene dichloride), polyethylene terephthalate (PET), oriented PET, silica, foil, polyamides, or mixtures thereof.

Other additional layers of the oxygen scavenging packaging article can include one or more layers which are permeable to oxygen. For example, one embodiment of the present invention, a packaging article, can be comprised of the following layers, in order starting from the outside of the packaging article to the innermost layer (forming the hollow interior) of the packaging article, (i) a structural layer, (ii) an oxygen barrier layer, (iii) an oxygen scavenging layer comprising an oxidizable organic compound and a transition metal catalyst, and optionally, (iv) an oxygen-permeable seal or food-contact layer. Control of the oxygen barrier property of (ii) allows regulation of the scavenging life of the package by limiting oxygen ingress from the atmosphere to the scavenging layer (iii), and thus slows the consumption of oxygen scavenging capacity by atmospheric oxygen. Layer (iv) can improve the heat-sealability, clarity, or resistance to blocking of the multi-layer packaging article. Also, control of the oxygen permeability of layer (iv) allows alteration of the rate of oxygen scavenging for the overall structure independent of the composition of the scavenging component (iii). Layer (iv) can permit oxygen from the headspace inside the package to pass to the oxygen scavenging layer (iii), while acting as a barrier to migration of the components of the scavenging layer, or by-products of scavenging, into the package interior.

Further additional layers, such as adhesive layers, can also be used in a multi-layer packaging article or film. Compositions typically used for adhesive layers include anhydride functional polyolefins and other well-known adhesive layers.

Oxygen scavenging layers and oxygen scavenging packaging articles of the present invention can be made by a number of different methods known in the art. For example, to prepare oxygen scavenging layers, films and articles, the desired components thereof can be melt-blended at a temperature between about 100° C. and about 300° C. Preferably the oxygen scavenging composition is photo-initiated to trigger oxygen scavenging. As an alternative, the oxygen scavenging composition can be heat triggered after melt-blending, and in that case the temperature required for triggering should be considered in choosing the melt-blend temperature and duration, along with other factors known to those of skill in the art. The blending can immediately precede the formation of the finished article, film or preform or precede the formation of a feedstock or masterbatch for later use in the production of finished packaging articles or films. When the blended composition is used to make an oxygen scavenging layer, film or a packaging article, (co-)extrusion, solvent casting, injection molding, stretch blow molding, orientation, thermoforming, extrusion coating, coating and curing, lamination, or combinations thereof would typically follow the blending.

All of the processes, compositions and apparatus disclosed and claimed herein can be make and executed without undue experimentation in light of the present disclosure. While the present invention has been described in terms of preferred embodiments, it will be apparent to those skilled in the art that variations may be applied to the processes, compositions and apparatus and in the steps or in the sequence of steps of the method described herein without departing from the concept, spirit and scope of the invention. More specifically, to will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A polymer esterification or transesterification process, comprising the steps of:
reacting a first polymer with a first alcohol in a reactive extruder apparatus to produce a second polymer, wherein a second alcohol is produced as a reaction by-product, and wherein the second alcohol has a lower boiling point than the first alcohol;
venting a gas stream from the extruder apparatus that comprises both first alcohol and second alcohol;
condensing at least part of the first alcohol from the gas stream, thereby forming a liquid stream and a vapor vent stream; and
feeding the liquid stream into the reactive extruder apparatus.

2. The process of claim 1, wherein the second alcohol has a boiling point at least about 100° C. lower than the boiling point of the first alcohol.

3. The process of claim 1, wherein the venting is accomplished using an atmospheric pressure vent apparatus.

4. The process of claim 1, wherein the venting is accomplished under a pressure that is greater that atmospheric pressure.

5. The process of claim 1, wherein the condensing of the gas stream is accomplished using a partial condenser apparatus.

6. The process of claim 5, wherein the temperature of the vapor vent stream is controlled by the partial condenser.

7. The process of claim 6, wherein the partial condenser is controlled by a vapor vent stream temperature controller.

8. The process of claim 1, wherein the liquid stream is sub-cooled prior to feeding the liquid stream into the reactive extruder apparatus.

9. The process of claim 5, wherein the vapor vent stream composition is controlled in response to the partial condenser.

10. The process of claim 9, wherein the partial condenser is controlled in response to a vapor vent stream composition analyzer.

11. The process of claim 5, wherein the liquid stream and gas stream are contacted in a contact section located between the partial condenser and the reactive extruder apparatus.

12. The process of claim 11, wherein the contact section contains packing, trays, or both.

13. The process of claim 1, wherein the first polymer has an ethylenic backbone.

14. The process of claim 13, wherein the first polymer comprises an ethylene-alkyl acrylate copolymer.

15. The process of claim 13, wherein the first alcohol comprises a terminal cycloalkenyl group.

16. The process of claim 15, wherein the first alcohol comprises a cycloalkenyl group having the formula (I): 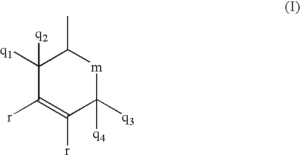
wherein q₁, q₂, q₃, q₄, and r are independently selected from hydrogen, methyl, or ethyl; m is —(CH₂)ₙ—, wherein n is an integer from 0 to 4, inclusive; and, when r is hydrogen, at least one of q₁, q₂, q₃, and q₄ is also hydrogen.

17. The process of claim 12, wherein the second polymer comprises a polyethylenic backbone and pendant groups having the formula (I): 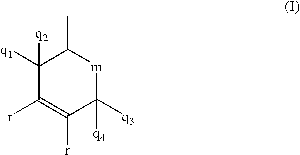
wherein q₁, q₂, q₃, q₄, and r are independently selected from hydrogen, methyl, or ethyl; m is —(CH₂)ₙ—, wherein n is an integer from 0 to 4, inclusive; and, when r is hydrogen, at least one of q₁, q₂, q₃, and q₄ is also hydrogen.

18. The process of claim 17, wherein the second polymer comprises an ethylene/alkyl acrylate/cycloalkenyl-alkyl acrylate terpolymer.

19. The process of claim 17, wherein the second polymer comprises poly(ethylene/methyl acrylate/cyclohexene-methyl acrylate).

20. The process of claim 1, wherein the second alcohol comprises methanol, isopropyl alcohol, or a mixture thereof.

21. The process of claim 1, wherein conversion of the first polymer to the second polymer is at least about 45%.
